(19) United States
(12) Patent Application Publication
(10) Pub. No.: US 2005/0202217 A1
(43) Pub. Date: Sep. 15, 2005

(54) Color handle of tool

(76) Inventor: Leo Shih, Taichung (TW)

Correspondence Address: LAW OFFICE OF LIAUH & ASSOC., 4224 WAIALAE AVE, STE 5-388, HONOLULU, HI, 96816, US

(21) Appl. No.: 10/797,851

(22) Filed: Mar. 9, 2004

(51) Int. Cl. B41M 5/20

(52) U.S. Cl. 428/195.1

(57) ABSTRACT

A tool comprises a handle having a first color pattern formed thereon, and a transparent first sheath formed of soft material and put on a rear end of the handle so as to completely exhibit a portion of the first color pattern enclosed therein. In another embodiment, a second sheath having a different color pattern formed thereon is put on the rear end of the handle prior to putting the first sheath on the second sheath.

### BACKGROUND OF THE INVENTION

1. Field of the Invention

The present invention relates to tools and more particularly to color handle(s) of a tool such as a pair of shears.

2. Description of Related Art

A pair of conventional shears are shown in FIG. 1. The shear comprises a handle 1 painted in one color and a gripping portion 2 formed of soft material in a different color, the gripping portion 2 being disposed over a rear end of the handle 1. However, such shears are aesthetically unattractive due to lack of color change.

One proposed solution for solving the above drawback is to print a color pattern on the handle 1 by thermo wax printing or water wax printing. Next, the gripping portion 2 in a different color is put the rear end of the handle 1. However, this also has the drawback of partially covering the color handle 1. One may devise that both the handle 1 and the gripping portion 2 are subject to the thermo wax printing or water wax printing process. However, the soft material of the gripping portion 2 may not be able to withstand the high temperature in the thermo wax printing or water wax printing process. Hence, a need for improvement exists.

### SUMMARY OF THE INVENTION

It is an object of the present invention to provide a tool comprising a handle having a first color pattern formed thereon; and a transparent first sheath formed of soft material and put on a rear end of the handle so as to completely exhibit a portion of the first color pattern enclosed therein.

It is another object of the present invention to provide a second sheath having a second color pattern formed thereon wherein the second color pattern is different from the first color pattern, and the second sheath is put on the rear end of the handle prior to putting the first sheath on the second sheath.

The above and other objects, features and advantages of the present invention will become apparent from the following detailed description taken with the accompanying drawings.

### BRIEF DESCRIPTION OF THE DRAWINGS

FIG. 1 is a perspective view of a pair of conventional shears having two handles in one color and two gripping portions in a different color;

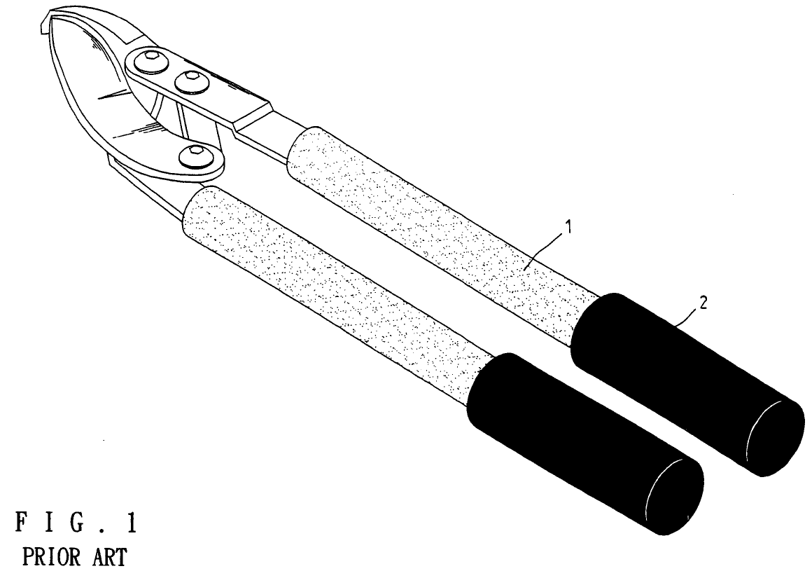

FIG. 2 is an exploded view of a preferred embodiment of shears having two color handles according to the invention;

FIG. 3 is an assembled view of the shears in FIG. 2;

FIG. 4 is an exploded view of another preferred embodiment of shears having two color handles according to the invention; and

FIG. 5 is an assembled view of the shears in FIG. 4.

### DETAILED DESCRIPTION OF THE PREFERRED EMBODIMENTS

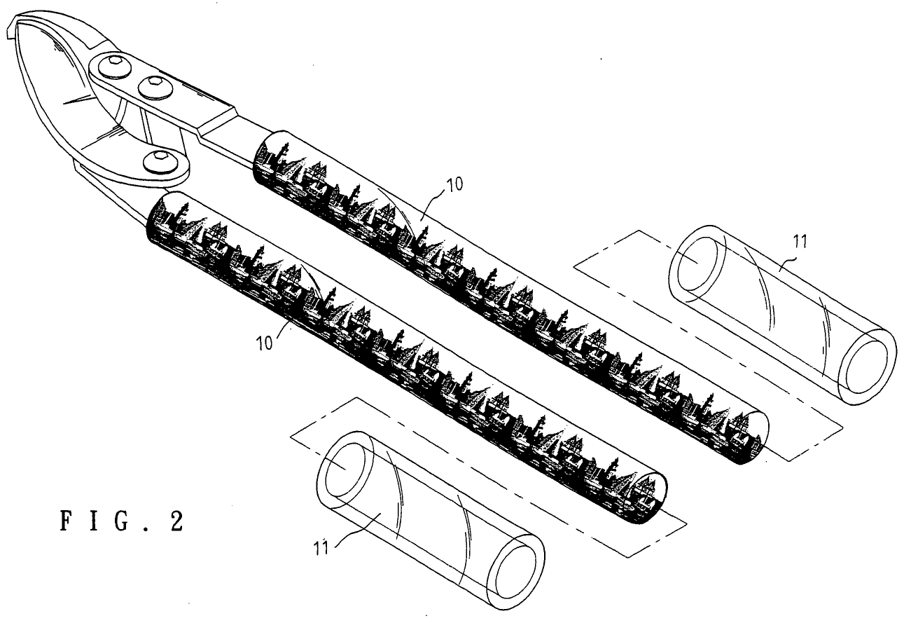

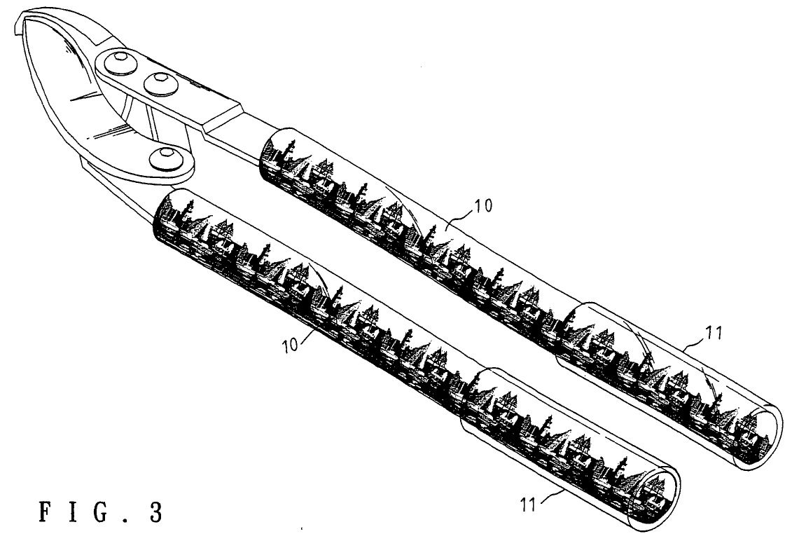

Referring to FIGS. 2 and 3, there is shown a pair of shears constructed in accordance with a preferred embodiment of the invention. Either cylindrical handle 10 of the shears is made of hard material and has a color pattern formed thereon by a thermo wax printing or water wax printing technique involving the steps of pressing a mold filled with color dye on a surface of the handle 10, heating the mold in a temperature about 180° C. for transferring dye onto the surface of the handle 10, and removing the mold after cool. Next, a transparent gripping portion 11 in the shape of sheath is put on a rear end of the handle 10. The gripping portions 11 have the advantages of providing a user with a degree of comfort while holding the handles 10 and completely exhibiting the color pattern formed on the surfaces of the handles 10.

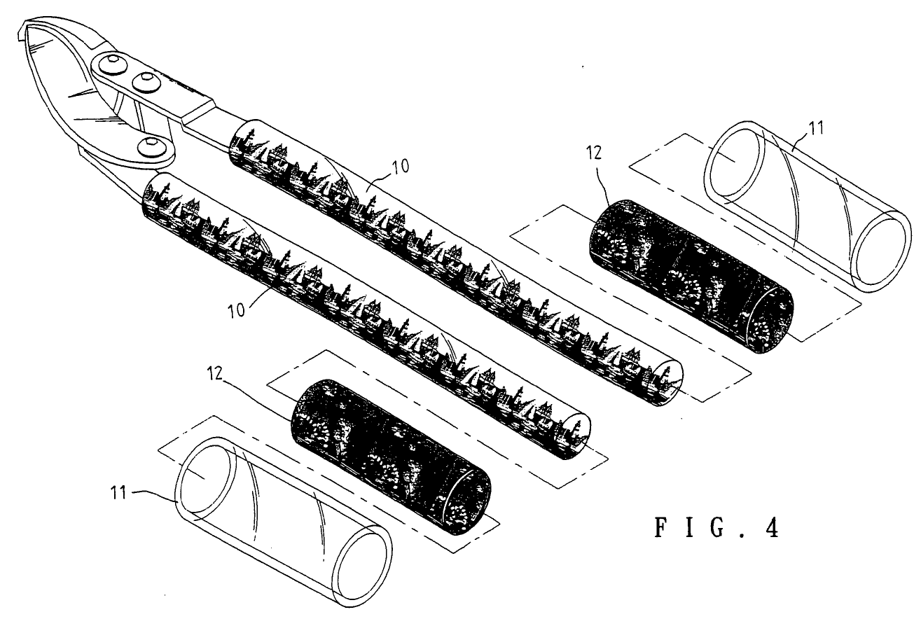

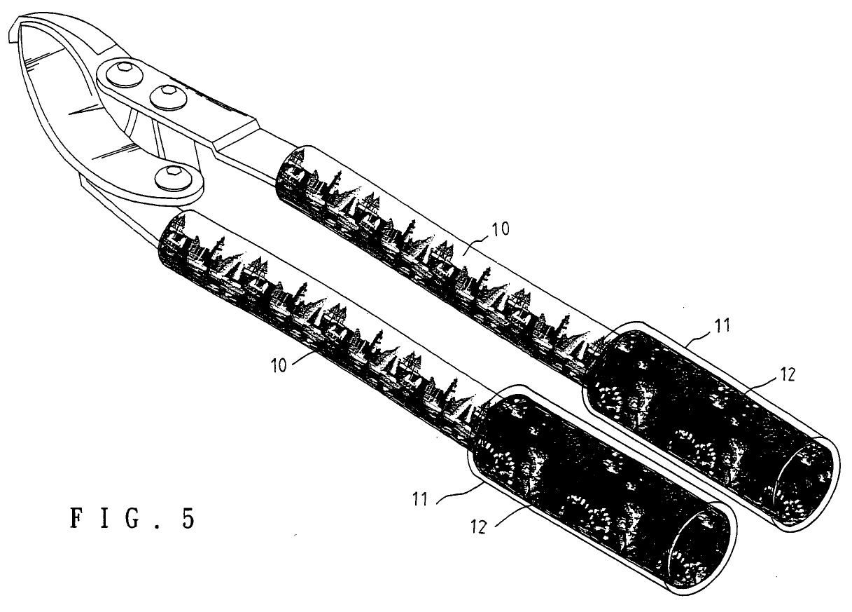

Referring to FIGS. 4 and 5, there is shown a pair of shears constructed in accordance with another preferred embodiment of the invention. The differences between these two preferred embodiments, i.e., the characteristics of another preferred embodiment are detailed below. A sheath (or sleeve) 12 having another color pattern formed thereon by a technique the same as above next, the sheath 12 is put on the rear end of the handle 10 prior to putting the transparent gripping portion 11 on the sheath 12. The advantages of the above embodiment can also be obtained.

While the invention herein disclosed has been described by means of specific embodiments, numerous modifications and variations could be made thereto by those skilled in the art without departing from the scope and spirit of the invention set forth in the claims.

1. A tool, comprising:
a handle having a first color pattern formed thereon; and
a transparent first sheath put on a rear end of the handle so as to completely exhibit a portion of the first color pattern enclosed therein.

2. The tool of claim 1, wherein the sheath is formed of soft material.

3. The tool of claim 1, further comprising a second sheath having a second color pattern formed thereon wherein the second color pattern is different from the first color pattern, and the second sheath is put on the rear end of the handle prior to putting the first sheath on the second sheath.
